(19) United States
(12) Patent Application Publication
(10) Pub. No.: US 2009/0317031 A1
(43) Pub. Date: Dec. 24, 2009

(54) ROLLER BEARING UNIT AND GAS CONTROL VALVE ARRANGEMENT COMPRISING A ROLLER BEARING UNIT

(75) Inventors: Harry Pfundt, Neustadt/Aisch (DE); Horst Steinbinder, Gundelsheim (DE); Peter Schaaf, Gutenstetten (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/514,876

(22) PCT Filed: Oct. 24, 2007
(86) PCT No.: PCT/EP07/61406

§ 371 Date: May 14, 2009

(30) Foreign Application Priority Data
Nov. 15, 2006 (DE) 10 2006 053 716.5

(51) Int. Cl. F16C 33/58; F02D 9/10; F16K 1/22; F16K 41/04

(52) U.S. Cl. 384/569; 251/306

(57) ABSTRACT

A roller bearing unit, in particular, a needle bearing unit, which has an outer ring, a roller body cage, roller bodies and several sealing rings. The roller bodies are housed in the roller body cage and are supported externally in the radial direction against the inner surface of the outer ring and are arranged to internally support a shaft aligned in the axial direction. The sealing rings are housed in the outer ring and designed to seal against a fluid flowing the axial direction. The sealing rings are arranged and/or designed such that the resultant sealing effect generated by the rings is direction dependent with relation to the fluids flowing in the axial direction.

The invention relates to a roller bearing unit, in particular a needle bearing unit, comprising an outer ring, a rolling body cage, rolling bodies and a plurality of sealing rings, the rolling bodies being received in the rolling body cage and being supported against the inner face of the outer ring in the radial direction on the outer side and being arranged on the inner side for mounting a shaft which is to be oriented in the axial direction, and the sealing rings being received in the outer ring and being configured for sealing with respect to fluids which flow in the axial direction. Furthermore, the invention relates to a gas control valve arrangement having the roller bearing unit.

Roller bearings often have additional functions in addition to their actual function, namely the mounting of, for example, shafts or axles. In particular, roller bearings are also used for insulating different regions in terms of pressure, with the result that the roller bearings at the same time assume the sealing function.

Published patent application DE 43 34 180 A1 describes a throttle valve apparatus, in which the throttle valve shaft is mounted by means of two bearing devices which are each configured in the form of a roller bearing, a needle bearing or a sliding bearing. As a result of the installation position, the bearing devices seal the gas conducting throttle region with respect to the surroundings. The sealing function is possibly assisted further by annular insert parts which are connected in front of the bearing devices, respectively.

Published patent application DE 43 33 676 A1 discloses a throttle valve apparatus, the throttle valve being moved by means of a throttle valve shaft which is mounted via roller bearings. In order to improve the sealing action, one seal each is connected in front of the roller bearings, in the form of sealing rings which bear against that bearing end face of the roller bearings which faces the throttle valve.

Published patent application DE 10 2004 043 125 A1 also concerns a throttle valve apparatus, in which the throttle valve shaft is mounted via roller bearing units. The roller bearing units comprise an outer ring, in which a rolling body cage is guided with a plurality of rolling bodies. In addition, the outer ring engages around two rings which are arranged on both sides of the rolling body cage and the function of which is not described in greater detail, however.

Published patent application DE 4235117A1, which appears to form the closest prior art, discloses a radial roller bearing which is used, for example, in the motor vehicle field for mounting the shafts of throttle valves in carburetors or injection systems. The radial roller bearing comprises an outer ring, in which a roller bearing cage, with rolling bodies, and two sealing rings are arranged. The sealing rings are positioned in each case on the end side with respect to the roller bearing cage and are oriented in terms of sealing direction in such a way that they prevent fluid from flowing into the roller bearing cage on both sides in the axial direction.

The invention is based on the object of proposing a roller bearing unit and a gas control valve arrangement which have increased operating reliability during use.

This object is achieved by a roller bearing unit having the features of claim 1 and a gas control valve arrangement having the features of claim 9. Preferred and/or advantageous embodiments of the invention are claimed by the subclaims or are disclosed in the following description and/or the figures.

The roller bearing unit according to the invention is configured, in particular, as a needle bearing unit and/or as a radial roller bearing unit or radial needle bearing unit. It comprises an outer ring, a rolling body cage, rolling bodies and a plurality of sealing rings.

The outer ring is preferably configured as an outer ring which is thin walled and/or formed without the removal of material, there preferably being provision for the outer face or outer contour to be configured for pushing or pressing the roller bearing unit into a bearing seat and/or for the inner face to be configured for rolling of the rolling bodies. At the end faces of the roller bearing unit, the outer ring preferably has a radially extending rim with a through hole each, the inside diameter of which is configured to be greater than the free internal diameter of the roller bearing unit (also called surrounding diameter). The outer ring is optionally realized in a single piece and/or hardened form, preferably casehardened or fully hardened, in particular with hardened rims.

The rolling body cage is preferably configured as a needle ring which holds the rolling bodies, in particular the needles, captively.

In the installed state, the sealing rings bring about a sealing action between the outer ring or indirectly the bearing seat and the shaft or axle which is mounted by way of the roller bearing unit, the sealing rings which are received in the outer ring being configured as radial seals for sealing with respect to fluids which flow in the axial direction. The sealing rings are preferably configured as seals, in particular as lip seals, which seal liquids and/or gas and/or are contacting.

There is provision according to the invention for the sealing rings to be realized in such a way that the overall sealing action of the roller bearing unit which is generated by the sealing rings is directionally dependent with respect to fluids which flow in the axial direction.

Here, the invention is based on the consideration of proposing a roller bearing unit which implements an asymmetrical sealing action as a closed structural unit. It has namely been recognized that, in a very large number of applications, a roller bearing, in addition to the actual bearing function, also serves to seal a region of higher pressure with respect to a region of lower pressure. In contrast to the solution approach followed consistently in the prior art of optionally reinforcing roller bearing units which seal symmetrically with additional sealing rings connected in front of them, the invention follows the path of proposing roller bearing units which seal asymmetrically. Here, the advantage of the invention lies, in particular, in easier mounting of the roller bearing units and in inexpensive production, since only sealing rings which are actually necessary for functional reasons are installed in the roller bearing unit.

For the purpose of the definition, a shutoff direction is defined which is oriented parallel to the axial extent of the shaft or axle to be mounted, and also a neutral direction which points in the opposite direction.

In one preferred embodiment, the directionally dependent overall sealing action is greater in the shutoff direction than in the neutral direction, the overall sealing action in the shutoff direction preferably being greater than the overall sealing action in the neutral direction by at least the proportion of the sealing action of the weakest sealing ring. This embodiment again emphasizes the inventive concept of proposing a roller bearing unit which is asymmetrical with regard to the overall sealing action.

The roller bearing unit is particularly preferably configured as a unit which is ready for mounting and/or ready for installation. Here, the rolling body cage, rolling bodies and the sealing rings are integrated and/or installed in the outer ring. This embodiment has the advantage that mounting faults of the roller bearing unit are virtually precluded and additionally, for example, necessary tests, in particular pressure tests, can be carried out by the manufacturer. The customer therefore receives a user friendly, pressure tested unit which is ready for installation.

One realization of the roller bearing unit which is advantageous on account of its simple design provides for each of the sealing rings which are used to be of structurally identical configuration. This design ensures that most fault sources are also eliminated during the mounting of the roller bearing unit.

There is provision, in particular, for the sealing rings to close the roller bearing unit on both sides and/or to be arranged on both sides of the rolling body cage. Given a suitable selection and positioning of the sealing rings, it can be ensured in this way that no fluids which flow in the axial direction can pass as far as the rolling body cage and therefore as far as the rolling bodies.

In one structural realization of the roller bearing unit, a high pressure side and a neutral pressure side are defined for said roller bearing unit, a higher pressure prevailing on the high pressure side than on the neutral pressure side in the installed position during operation. One measure for achieving the asymmetrical sealing action is to arrange a greater number of sealing rings on the high pressure side than on the neutral pressure side.

In a further measure which is either supplementary or alternative, the sealing rings have a sealing direction, the sealing direction corresponding here to the shutoff direction of the individual sealing ring, and a plurality of the sealing rings or all the sealing rings being oriented in the same direction with regard to the sealing direction.

As a further optional measure, one or more annular sealing chambers which extend radially and are filled with grease is/are provided within the roller bearing unit. Said sealing chambers are arranged, for example, between the sealing rings or between the sealing ring and the rolling body cage. As an alternative or in addition, the roller bearing cage is configured as a sealing chamber, the latter being filled for this purpose with grease except for the passage for the axle or the shaft. The grease which is contained in the sealing chambers serves as sealing medium which acts as a seal which is, in particular, gastight.

The above-mentioned measures can be used individually or in combination. Sealing rings with different thicknesses, that is to say with different sealing actions, and/or different designs can also be used, in order to implement the asymmetrical sealing characteristics.

A further subject matter of the invention relates to a gas control valve arrangement, in particular an exhaust gas control valve arrangement, having the features of claim 9.

The gas control valve arrangement comprises a gas control valve for manipulating a gas flow in a flow region, and a gas control valve shaft which is connected operatively to the gas control valve and controls the latter mechanically. According to the invention, the gas control valve shaft is mounted at least on one side with a roller bearing unit as claimed in one of the preceding claims or according to the preceding description.

This subject matter of the invention develops the inventive concept by the roller bearing unit with asymmetrical sealing characteristics being used for a specific application. In the case of exhaust gas control valve arrangements, in particular, it has been determined that the sealing action between the exhaust gas channel to be controlled and the surroundings is improved considerably by the novel roller bearing units. As a result, in particular, a solution for eliminating blowby gases has been found, which blowby gases threaten to escape into further regions of the exhaust gas control valve arrangement, on account of the pronounced pressure difference between the exhaust gas channel to be controlled and said further regions of the exhaust gas control valve arrangement, and can influence, for example, electrics or drive motors for controlling the exhaust gas control valves in said further regions. The gas control valve arrangement according to the invention overcomes this problem by the use of the roller bearing unit according to the invention which on the one hand has the required sealing action and on the other hand does not have any considerably increased dimensions or measurements in the radial direction in comparison with conventional roller bearings. Preferred application fields of the gas valve arrangement according to the invention are, for example, the use in supercharged diesel or gasoline engines, in particular in conjunction with superchargers or turbochargers.

The roller bearing unit is particularly preferably used in a gas control valve arrangement, in which the flow region has a higher pressure than a neutral region, which regions are sealed from one another by the roller bearing unit in a fluidtight manner, in particular in a gastight manner, which higher pressure is higher during operation at least temporarily by at least two (2) bar, preferably by at least three (3) bar, and in particular by at least four (4) bar.

In one structural realization, electric components and/or an actuating motor for the motorized movement of the gas valve shaft are/is arranged in the neutral region. The neutral region is insulated in a sufficiently pressuretight manner with respect to the flow region by the novel roller bearing unit, with the result that no leaks occur at the gas control valves and an ingress of blowby gases into the electrics, etc. is avoided.

There is provision as an optional measure, starting from the flow region, for one or more sealing rings to be connected in front of and/or behind the roller bearing unit on the gas control valve shaft. Said sealing rings can be configured, for example, as radial seals which are, in particular, prestressed by spring.

As a further optional measure, outflow holes for discharging fluid are inserted between the sealing ring or sealing rings which is/are connected in front or behind and the roller bearing unit. Said outflow holes serve to return fluid which has accumulated between the sealing ring and the roller bearing unit into the flow region.

A further possible measure is formed by the use of a splash ring or a splash plate which is preferably connected rigidly to the gas control valve shaft or to the bearing seat for the roller bearing unit and serves to prevent and/or to minimize a contact between the gas flow in the flow region and the seals or the roller bearing unit.

Further advantages, features and effects of the invention result from the following description of preferred exemplary embodiments of the invention and the appended figures, in which:

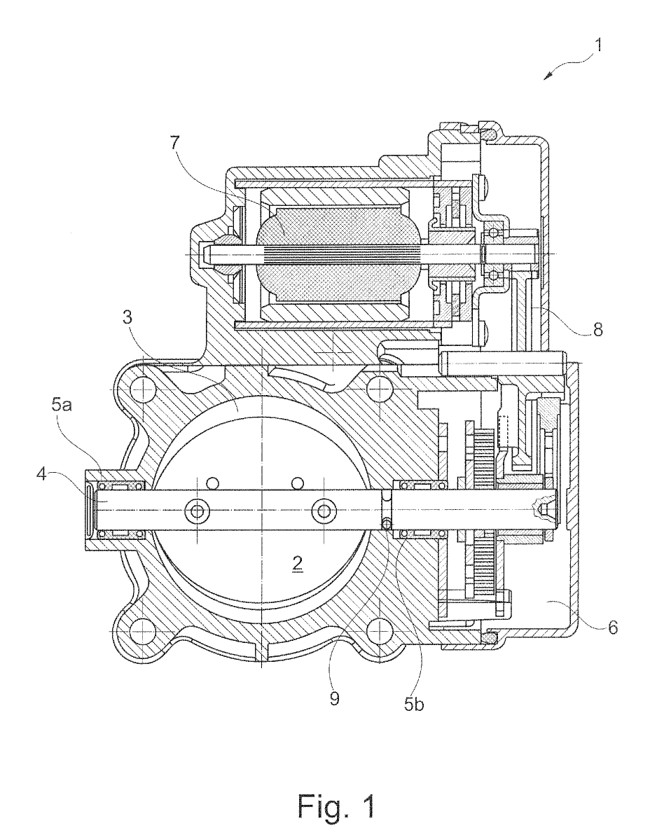

FIG. 1 shows a cross-sectional illustration of one exemplary embodiment of an exhaust gas control valve arrangement according to the invention;

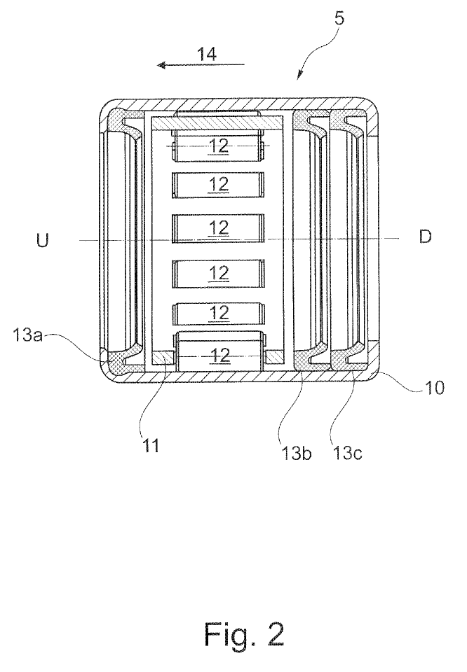

FIG. 2 shows a cross-sectional illustration of a first exemplary embodiment of a bearing unit according to the invention for use in the exhaust gas control valve arrangement in FIG. 1;

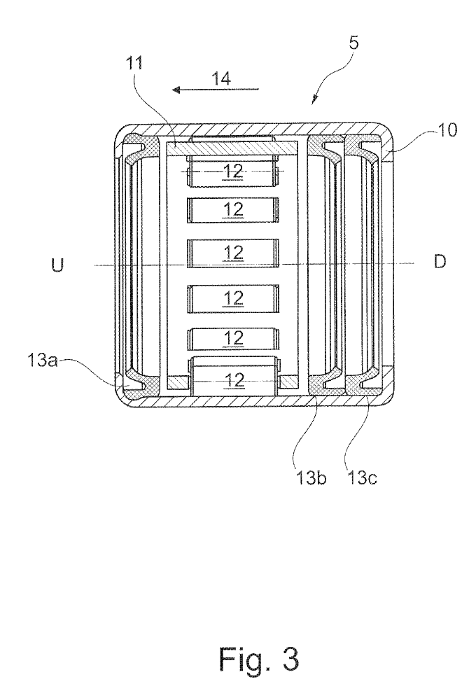

FIG. 3 shows a cross-sectional illustration of a second exemplary embodiment of a bearing unit according to the invention for use in the exhaust gas control valve arrangement in FIG. 1;

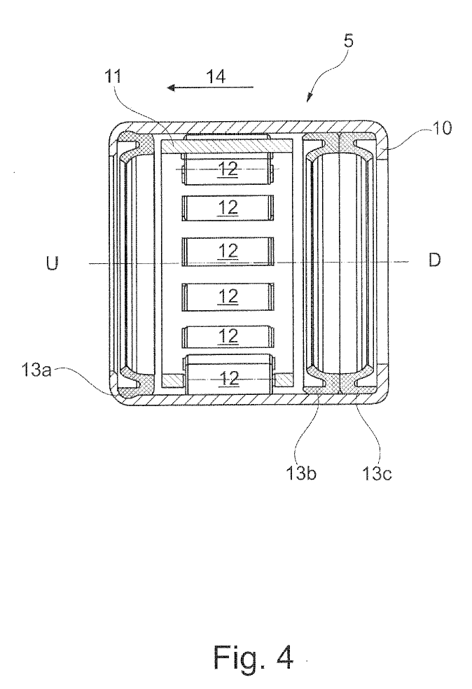

FIG. 4 shows a cross-sectional illustration of a third exemplary embodiment of a bearing unit according to the invention for use in the exhaust gas control valve arrangement in FIG. 1;

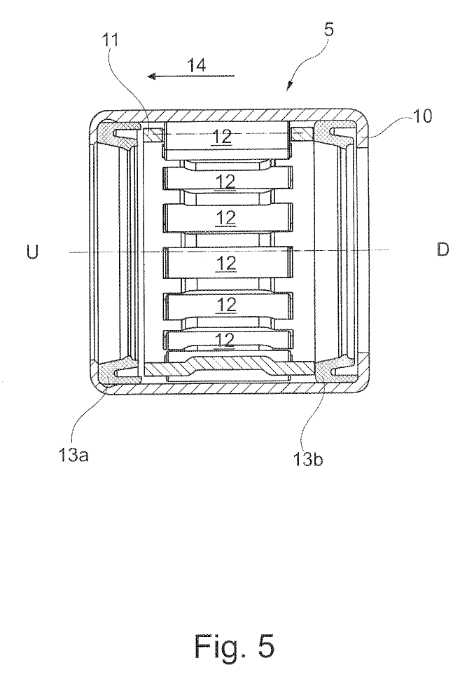

FIG. 5 shows a cross-sectional illustration of a fourth exemplary embodiment of a bearing unit according to the invention for use in the exhaust gas control valve arrangement in FIG. 1;

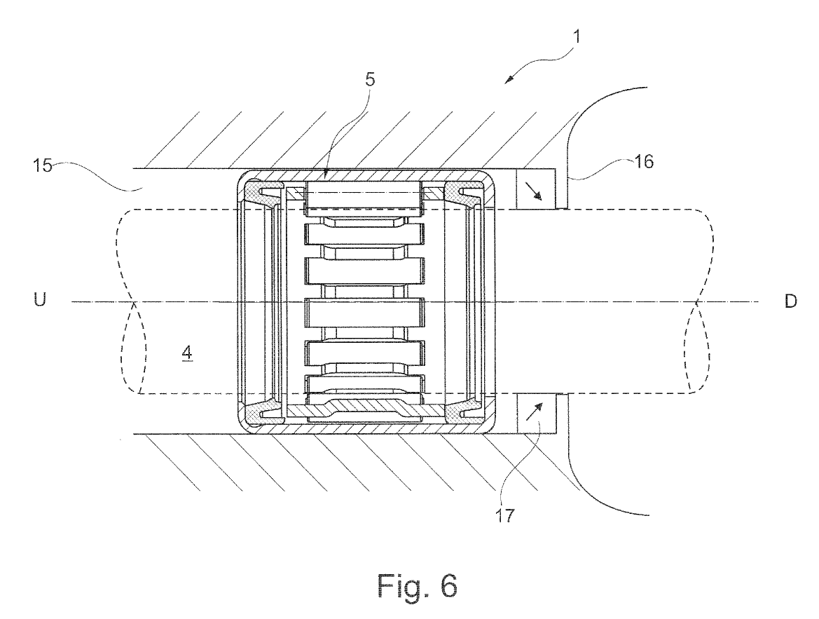

FIG. 6 shows a detailed view in a cross-sectional illustration of the exhaust gas control valve arrangement in FIG. 1 with the fourth exemplary embodiment of the bearing unit in a first arrangement;

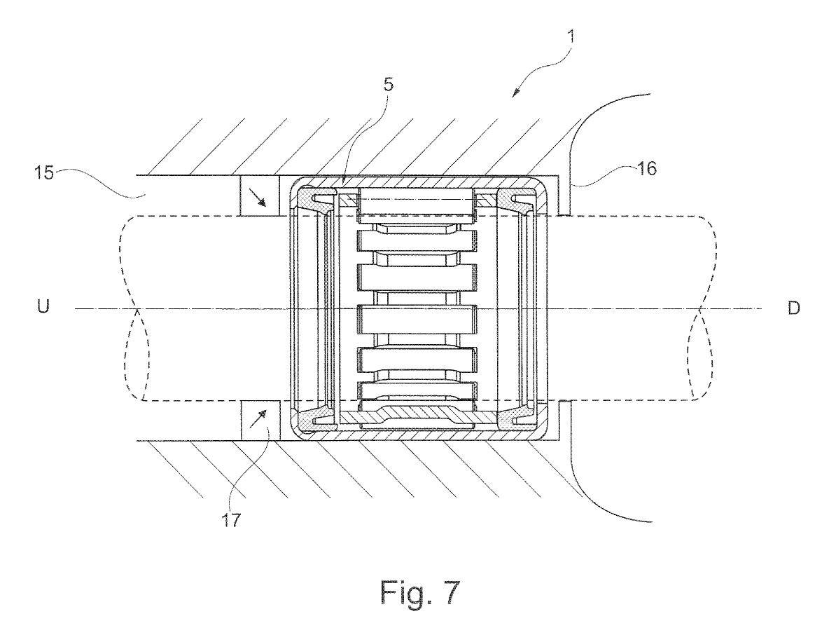

FIG. 7 shows a detailed view in a cross-sectional illustration of the exhaust gas control valve arrangement in FIG. 1 with the fourth exemplary embodiment of the bearing unit in a second arrangement.

Identical or corresponding designations denote respectively identical or corresponding parts or magnitudes.

In a tiered cross-sectional illustration, FIG. 1 shows an exhaust gas control valve arrangement 1, as is used, for example, in turbochargers or the like in supercharged diesel and/or gasoline engines. A passage through a gas channel 3 is controlled with the aid of a throttle valve 2 in the form of a circular or elliptical metal orifice plate. The exhaust gases to be throttled are guided in the gas channel 3 which is oriented perpendicularly with respect to the plane of the sheet in FIG. 1, the flow of the exhaust gases being throttled to a greater or lesser extent depending on the pivoting position of the throttle valve 2.

The throttle valve 2 is connected fixedly to a throttle valve shaft 4, the throttle valve 2 being mounted such that it can be pivoted about a center axis. On account of this mounting, the throttle valve 2 can usually be pivoted about its center axis by up to 90°, in order to largely release the passage of the exhaust gas channel, or can be pivoted to 0°, in order to shut off the passage and to throttle the exhaust gas flow to the maximum extent. The throttle valve shaft 4 is mounted rotatably or pivotably on both sides by means of identically configured bearing units 5a, 5b. The precise configuration of the bearing unit 5a or 5b is explained using the following figures.

In order to actuate the throttle valve 2, the throttle valve shaft 4 extends in the axial direction into a control installation space 6, in which a motor 7 is installed for the motorized movement of the throttle valve 2 and a gear mechanism 8 is installed for transmitting the rotational movement of the motor 7 to the throttle valve shaft 4.

The exhaust channel 3 and the control installation space 6 are insulated from one another in terms of pressure by means of the bearing unit 5b which is connected between these regions. In operation, the exhaust channel 3 can be called a high pressure region, in which absolute pressures of greater than two (2), three (3) or four (4) bar can occur. In contrast, the control installation space 6 is a neutral pressure region, in which ambient pressure usually prevails. In operation, the pressure difference between the exhaust channel 3 and the control installation space 6 can therefore be more than 2 bar, in particular more than 3 bar or else more than 4 bar. There is the risk on account of this pressure difference that exhaust gases from the exhaust channel 3 penetrate via the bearing unit 5b into the control installation space 6. Said blowby gases are critical for reliable operation of the gear mechanism 8 and the motor 7 and for further electric and/or electronic components which are possibly arranged in the control installation space 6. In order to avoid a fluid which flows in the axial direction parallel to the throttle valve shaft 4, an O-ring 9 which is connected in front of the bearing unit 5b is provided as a first optional measure in the exhaust gas control valve arrangement in FIG. 1.

Following FIGS. 2 to 5 each show bearing units 5, as can be used advantageously as bearing units 5a, 5b in the exhaust gas control valve arrangement 1 in FIG. 1. In the illustrations, the letter D denotes in each case the throttle valve side and the letter U shows the surroundings or control installation space side.

In a cross-sectional illustration, FIG. 2 shows a first exemplary embodiment of the bearing unit 5. The bearing unit 5 has an outer ring 10 which is, in particular, of single piece configuration and in which a rolling body cage 11 and a plurality of rolling bodies 12 and three sealing rings 13a, 13b, 13c of identical configuration are arranged. The rolling body cage 11 is realized for receiving the rolling bodies 12, which are configured, in particular, as needles, and is arranged in the outer ring 10 in such a way that the rolling bodies 12 roll on the radial outside on the inner face of the outer ring 10. As can be gathered from FIG. 2, the sealing rings 13a, 13b and 13c are distributed asymmetrically around the rolling body cage 11, the sealing ring 13a being arranged on the surroundings side U and two sealing rings 13b and 13c being arranged on the throttle valve side D. The sealing rings 13a, 13b, 13c are configured as lip sealing rings which achieve the sealing action by way of mechanical contact of the exhaust gas throttle shaft 4 which is to be mounted in the axial direction (see FIG. 1). All three sealing rings 13a, 13b, 13c are oriented identically with regard to the sealing action, to be precise in such a way that the sealing or shutoff direction (arrow 14) of the sealing rings 13a, 13b and 13c extends from the throttle valve side D to the surroundings side U. In this way, the bearing unit 5 realizes a sealing characteristic which allows a higher maximum pressure to be sealed by the throttle valve side D and a lower maximum pressure to be sealed by the surroundings side U.

FIG. 3 shows a modified embodiment of the bearing unit 5 in FIG. 2, only the sealing rings 13b and 13c which are mounted on the throttle valve side D being oriented in the same direction in such a way that the shutoff direction extends from the throttle valve side D to the surroundings side U. In contrast, the sealing ring 13a which is mounted on the surroundings side U is mounted in the opposite direction, with the result that the shutoff direction extends from the surroundings side U to the throttle valve side D. This arrangement of the sealing rings 13a, 13b and 13c ensures that no fluid can penetrate in the axially flowing direction into the roller bearing cage 11 from the surroundings side U either.

FIG. 4 shows a further modified embodiment of the bearing unit 5 in FIGS. 2 and 3, the sealing ring 13c being mounted in the shutoff direction and the sealing rings 13a and b being mounted in the same direction as the former.

In the same illustration as in FIGS. 2, 3 and 4, FIG. 5 shows a bearing unit 5 which has a modified bearing cage 11 and, in contrast to the bearing unit 5 in FIGS. 2, 3 and 4, has only two sealing rings 13a and 13b which are arranged on both sides of the modified bearing cage 11. The sealing rings 13a and b are oriented in the same direction, the sealing or shutoff direction (arrow 14) of both sealing rings 13a and 13b extending again from the throttle valve side D to the surroundings side U.

FIG. 6 shows the bearing unit 5 in FIG. 5 in an installed state in the exhaust gas control valve arrangement 1, as a detail. In order to receive the bearing unit 5, the exhaust gas control valve arrangement 1 has a cylindrical bearing seat 15 which is stepped on the throttle valve side D by an integrally formed splash ring 16. The free diameter of the splash ring 16 is adapted to the external diameter of the throttle valve shaft 4, with the result that the latter can be pivoted freely in the splash ring 16. The splash ring 16 is an optional measure, in order to mechanically keep the exhaust gases which flow in the exhaust channel 3 from the sealing region.

As a further measure for boosting the sealing action in the shutoff direction (arrow 14), a radial seal 17 which is mounted outside of the outer ring 10 or bearing unit 5 is provided for sealing the throttle valve shaft 4, which radial seal 17 bears against that side of the splash ring 16 which faces away from the exhaust channel 3, said radial seal 17 being connected in front of the bearing unit 5 starting from the throttle valve side D and being largely covered by the splash ring 16 in the radial direction. The radial seal 17 is optionally configured as a sealing ring or lip sealing ring which is prestressed, in particular, by spring, the shutoff direction of the radial seal 17 being oriented from the throttle valve side D to the surroundings side U.

FIG. 7 shows a similar arrangement to FIG. 6, in contrast to FIG. 6 the additional radial seal 17 being connected behind the bearing arrangement 5 starting from the throttle valve side D, but having the same shutoff direction here.

As a further optional possibility to increase the sealing action, the bearing units 5 (FIGS. 2, 3, 4, 5) can be filled with grease in the region of the rolling body cage 11, with the result that the introduced grease acts as a sealing medium with respect to axially running fluids.

1. A roller bearing unit comprising:
an outer ring;
a rolling body cage;
rolling bodies, the rolling bodies being received in the rolling body cage and being supported against an inner face of the outer ring in a radial direction on an outer side and being arranged on an inner side for mounting a shaft which is oriented in an axial direction; and,
a plurality of sealing rings, the sealing rings being received in the outer ring and being configured for sealing with respect to fluids which flow in the axial direction, wherein
the sealing rings are arranged such that overall sealing action of the roller bearing unit, which is generated by the sealing rings, is directionally dependent with respect to fluids which flow in the axial direction.

2. The roller bearing unit as claimed in claim 1, wherein the overall sealing action is greater in a shutoff direction than in a neutral direction, the overall sealing action in the shutoff direction being boosted by at least the overall sealing action of one of the weakest sealing rings with respect to the overall sealing action in a neutral direction.

3. The roller bearing unit as claimed in claim 1, wherein a configuration as a unit is ready for mounting.

4. The roller bearing unit as claimed in claim 1, wherein the sealing rings are structurally identical.

5. The roller bearing unit as claimed in claim 1, wherein the sealing rings close the roller bearing unit on both sides and are arranged on both sides of the rolling body cage.

6. The roller bearing unit as claimed in claim 1, wherein the roller bearing unit has a high pressure side and a neutral pressure side, a greater number of sealing rings being arranged on the high pressure side than on the neutral pressure side.

7. The roller bearing unit as claimed in claim 1, wherein the sealing rings have a sealing direction, and a plurality of the sealing rings or all the sealing rings are oriented in the same direction with regard to the sealing direction.

8. The roller bearing unit as claimed in claim 1, wherein one or more annular sealing chambers are filled with grease.

9. A gas control valve arrangement having a gas control valve for influencing the gas flow in a flow region, and a gas control valve shaft for controlling the gas control valve, wherein the gas control valve shaft is mounted at least on one side with a roller bearing unit as claimed in claim 1.

10. The gas control valve arrangement as claimed in claim 9, wherein the flow region is sealed in a fluidtight manner with respect to a neutral region by the roller bearing unit, pressure difference between the flow region and the neutral region being at least temporarily at least 2 bar, preferably at least 3 bar, and in particular at least 4 bar during operation of the gas control valve arrangement.

11. The gas control valve arrangement as claimed in claim 10, wherein electric components and/or an actuating motor for motorized movement of the gas control valve shaft are/is arranged in the neutral region.

12. The gas control valve arrangement as claimed in claim 9, wherein at least one radial seal is connected in front of or behind the roller bearing unit on the gas control valve shaft.

13. The gas control valve arrangement as claimed in claim 12, wherein outflow holes for discharging fluid are provided between the roller bearing unit and the radial seal which is connected in front of or behind it.

14. The gas control valve arrangement as claimed in claim 9, wherein the roller bearing unit is protected with respect to the flow region by a splash ring.
